(19) United States
(12) Patent Application Publication
(10) Pub. No.: US 2010/0250330 A1
(43) Pub. Date: Sep. 30, 2010

(54) ACQUISITION OF USER DATA TO ENHANCE A CONTENT TARGETING MECHANISM

(76) Inventors: CHUCK LAM, San Francisco, CA (US); Ibrahim Okuyucu, Santa Clara, CA (US)

Correspondence Address: Raj Abhyanker, P.C., 1580 West, El Camino Real, Suite 8, Mountain View, CA, 94040, US

(21) Appl. No.: 12/413,565

(22) Filed: Mar. 29, 2009

(51) Int. Cl. G06Q 30/00; G06Q 99/00; G06Q 10/00

(52) U.S. Cl. 705/10; 705/319; 705/14.66

(57) ABSTRACT

Disclosed are a method and system of acquisition of user data to enhance a content targeting mechanism. A method includes acquiring a personalized user data Δ available from an external source using an external access regulator authorization α. The method further includes algorithmically selecting a targeted media content based on the personalized user data Δ, and publishing the targeted media content through a display module.

### FIELD OF TECHNOLOGY

This disclosure relates generally to acquisition of user data to enhance a content targeting mechanism.

### BACKGROUND

A marketing network may seek a marketing media (e.g., an advertisement, a brochure, a video clip, etc.) that results in a user click-through. The marketing media may be a part of an electronically published content (e.g., a website, a news video, an audio clip presented on a web site, etc.). The user click-through (e.g., an input device communication, a mouse-click, a touch pad signal, etc.) may be an indication of interest by the user in the electronically published media. The marketing network may use a subjective human judgment (e.g., trial and error, a census review, etc.) to choose and/or develop the marketing media. As a result, the marketing media chosen and/or developed by the marketing network may fail to result in a user click-through, which may lead to a failure to obtain a click-through associated revenue.

### SUMMARY

A method and system of acquisition of user data to enhance a content targeting mechanism are disclosed. An exemplary embodiment provides a method that includes acquiring a personalized user data Δ available from an external source using an external access regulator authorization α. In addition, the method includes automatically selecting a targeted media content based on the personalized user data Δ. The method further includes publishing the targeted media content through a display module.

An exemplary embodiment provides a system that includes a capture module, an association module, a display module and a database. The capture module acquires a personalized user data Δ that is available from an external source using the external access regulator authorization α. The association module algorithmically selects a targeted media content from a database based on the personalized user data Δ. The display module publishes the targeted media content.

An exemplary embodiment provides a method that includes detecting an external access regulator authorization α of a user through a computer process after a publishing server has been accessed. In the embodiment, an external access regulator is operated by a social networking server. The method further includes acquiring a personalized user data Δ available from the social networking server using the external access regulator authorization α. The personalized user data Δ relates to one or more of the users and additional users that is socially connected to the user. In addition, the method includes algorithmically selecting a targeted media content based on the personalized user data Δ. The method also includes publishing the targeted media content through a display module and monitoring a user access of the display module. An interaction data of the user and the display module is generated that includes at least one of a click-through, a viewed content, a time of viewing, a viewing rate, a rating, and a communication. The interaction data is correlated with an aspect of a display module data. Other aspects and example embodiments are provided in the drawings and the detailed description that follows.

### BRIEF DESCRIPTION OF THE FIGURES

Example embodiments are illustrated by way of example and not limitation in the figures of the accompanying drawings, in which like references indicate similar elements and in which:

FIG. 1 is a system view illustrating a user accessing a network and various modules, according to one embodiment.

FIG. 2 is an algorithmic view of the user accessing a publishing server, according to one embodiment.

FIG. 3 is a user interface view illustrating a display module, according to another embodiment.

FIG. 4 is a tabular view of acquiring the user data to enhance a content targeting mechanism, according to yet another embodiment.

FIG. 5 is a process flow illustrating detection of an external access regulator authorization α, according to one embodiment.

FIG. 6 is a diagrammatic system view of a data processing system in which any of the embodiments disclosed herein may be performed, according to one embodiment.

Other features of the present embodiments will be apparent from the accompanying drawings and from the detailed description that follows.

### DETAILED DESCRIPTION

A method and system of acquisition of user data to enhance a content targeting mechanism are disclosed. Although the present embodiments have been described with reference to specific example embodiments, it will be evident that various modifications and changes may be made to these embodiments without departing from the broader spirit and scope of the various embodiments.

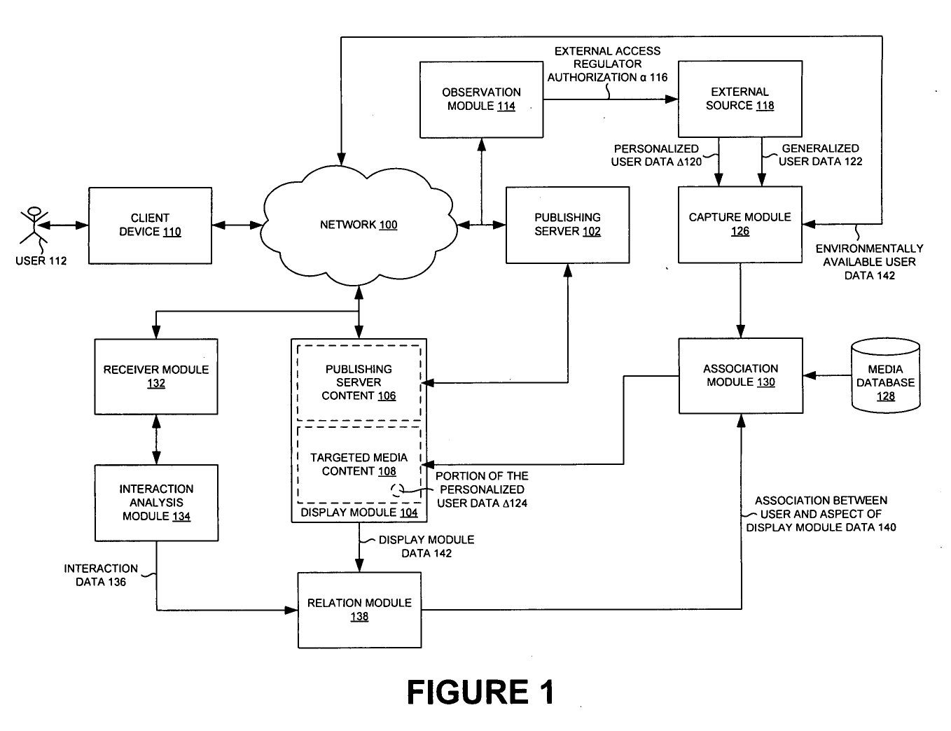

FIG. 1 is a system view illustrating a user accessing a network and various modules, according to one embodiment. Particularly, FIG. 1 illustrates a network 100, a publishing server 102, a display module 104, a publishing server content 106, a targeted media content 108, a client device 110, a user 112, an observation module 114, an external access regulator authorization a 116, an external source 118, a personalized user data Δ 120, a generalized user data 122, a portion of the personalized user data Δ 124, a capture module 126, a media database 128, an association module 130, a receiver module 132, an interaction analysis module 134, an interaction data 136, an association module 138, and an association between a user and an aspect of a display module data 140, according to one embodiment.

The user 112 may access a display module 104 via the network 100 and/or the client device 110. The user 112 may be a person, an entity, a program, a business, and/or a machine that accesses the display module 104. The user 112 may be a person who is interested in viewing and/or interacting with the publishing server content 106 and/or the targeted media content 108. The client device 110 may be a terminal, a client software application, a computer, a server, a mobile device, etc. The display module 104 may be a monitor, a web page, etc. The publishing server content 106 and/or the targeted media content 108 may be text, audio files, software, games, video files, images, etc. The network 100 may be comprised of a system of interconnected software and/or hardware modules through which information may be transmitted and/or received. The network 100 may include a LAN, a WAN, a MAN, or any other type of network.

After the user 112 has accessed the network 100, the publishing server 102, and/or the display module 104, the observation module 114 may detect an external access regulator authorization α 116, which may be associated with and/or used by the user 112. The external access regulator authorization α 116 may be detected using a computer process. The external access regulator authorization α 116 may be detected by inferring its existence based on a publishing server process that requires the external access regulator authorization α 116. The external access regulator authorization α 116 may be a password, a key, a code, etc. The external access regulator may be a single sign-on and/or sign off service (e.g., Facebook Connect, MySpace Data Availability, Google Friend Connect, etc.) that allows a user 112 to access multiple software services with a single log in. The external access regulator may provide registration and/or data services to external software service providers and/or servers, which may including providing access to access regulator information pertaining to the user 112 (e.g., an online identity profile, a social network, an account history, etc.).

The user 112 may not be asked for an additional login to access other programs, web sites, servers, machines, etc., after logging in once. The single sign on service may allow the user 112 to also log out of multiple services with a single log out. The external access regulator may use a Kerberos® based system, a smart card, a one time password token, and an integrated windows authentication. The external access regulator may also use a shared authentication system (e.g., OpenID) and/or an enterprise single sign on service. The external access regulator may be operated by a social networking server (e.g., a Facebook server, a Myspace server, a Second Life server, etc.).

After the external access regulator authorization a 116 has been detected, the capture module 126 may use it to acquire the personalized user data Δ 120 and/or the generalized user data 122 from the external source 118. The capture module 126 may be executed on the client device 110 (e.g., the module may be javascript code, etc.) and/or on a server. The capture module 126 may include a component executing on the client device 110 while an additional component of the capture module 126 is executing on the server. The component (e.g., javascript code executing on the client device 110) may read user data from the external source 118 (e.g., Facebook®). The additional component may read the environmentally available user data 142 (e.g., a user cookie).

The external source 118 may be a third party web site server, a social networking server (e.g., Facebook, Friendster, Second Life, etc.), a public record server (e.g., a driver's license registration, a marriage license, a property ownership, etc.), and/or a commercial website server (e.g., Amazon, Netflix, LinkedIn, etc.).

The personalized user data Δ 120 may include an online identity of a social network (e.g., Facebook, Myspace, etc.). The personalized user data Δ 120 may include a name, an age, a gender, an image, an interest, an associated account, a communication, a social graph, a social network, a purchase activity, an installed application, and an account history. The personalized user data Δ 120 may include information relating to the user 112 and/or to an additional user that is socially connected to the user 112. The names may include the user's 112 name and names of persons who are friends of the user 112 or are otherwise linked to the user 112. The image may include images of the user 112, locations associated with the user 112, and/or images of people associated with the user 112. The social graph and/or social network may illustrate a relationship between the user 112 and other people, entities, and/or interests (e.g., causes, fansites, etc.).

The purchase activity may be items purchased and/or sold by the user 112. The installed application may be software (e.g., a game, a program, etc.) installed by the user 112 on a social networking site. The account history may include the user 112's account creation date, privacy settings, communications with other persons and/or entities, dates of applications installed and/or removed, etc. The account history may include recent and/or dated information regarding status updates, including with regard to relationships, employment, locations, travel, business, and comments on other persons.

The generalized user data 122 may be a categorization of the personalized user data Δ 120 and/or an extrapolated information from the personalized user data Δ 120. The generalized user data 122 may be generated and/or acquired in order to comply with a information sharing restriction of the external source 118 and/or the publishing server 102. For example, the generalized user data 122 may be an age range rather than an age. In addition, it may include a gender, and it may include a general area rather than a specific address. The generalized user data 122 may include substantially all of the personalized user data Δ 120 that does not identify a specific user 112 and/or an additional user associated with the user 112.

The capture module may acquire an environmentally available user data 142 from active user software based on an access of the publishing server. The environmentally available user data 142 may include a partial content of data received and/or transmitted by the user 112, which may be used to generate a contextual advertisement. The environmentally available user data 142 may include information stored in a browser cookie. In an embodiment, the environmentally available user data 142 may include any data associated with the user 112 from active software running on the user's 112 PC, terminal, thick client, client device 110, and/or any other server and/or processor. The environmentally available user data 142 may include stored data accessible to active software associated with the user 112.

The association module 130 may use the personalized user data Δ 120 and/or the generalized user data 122 to algorithmically select and/or develop the targeted media content 108 from information stored on the media database 128. The media database 128 may include an internal source of user data. The association module 130 may acquire the personalized user data Δ 120 and/or the generalized user data 122 from the external source 118 and/or an internal source of user data. The internal source of user data may include the client device 110, the environmentally available user data 142, the media database 128, the publishing server 102, and/or a marketing network server.

The selection and/or development of the targeted media content may use and/or be affected by the environmentally available user data 142 and/or an association between the user 112 and an aspect of the display module data 140. The targeted media content 108 may include all or a part of the personalized user data Δ 120 and/or the generalized user data 122. For example, the targeted media content 108 may be an image that includes the user's 112 face, and/or the face of persons associated with the user 112 in the external source 118. The portion of the personalized user data Δ 124 may be a text file, an image of a person and/or a name of the user 112 and/or an additional user associated with the user 112. The targeted media content 108 may be advertising, a feed message, video content, audio content, and/or software.

The targeted media content 108 may be published through the display module 104, which may also display the publishing server content 106. The targeted media content 108 may include a portion of the personalized user data Δ 124. A receiver module 132 may monitor a user 112 access of the display module, which may include monitoring the amount of time the user 112 viewed parts of the material on the publishing server content 106, the information that was transmitted and/or received by the user 112, whether information from the display module 104 was forwarded to another person, and/or whether the user 112 clicked on and/or otherwise engaged the material published using the display module 104.

The interaction analysis module 134 may generate an interaction data 136 of the user and the display module. The interaction data 136 may include a click-through, a viewed content, a viewing rate, a rating, the data published using the display module 104, the user 112 actions monitored by the receiver module 132, a metadata associated with the interaction (e.g., a time of viewing, a file size, etc.), and/or an analysis result. The analysis result may include a comparison between an anticipated action and an actual user 112 activity.

The relation module 138 may correlate the interaction data 136 with the display module data 142. The relation module 138 may provide an association between the user and an aspect of the display module data 140 to the association module 130, which may affect the selection of the targeted media content 108. The association module 130 may dynamically respond to the interaction data 136 to alter the selection and/or development of the targeted media content 108 with respect to users 112 with similar characteristics. The dynamic response of the association module 130 may include generating a response of an interactive targeted media content 108 (e.g., an audio response of the targeted media content 108 in response to a verbal statement and/or body language of the user 112, etc.).

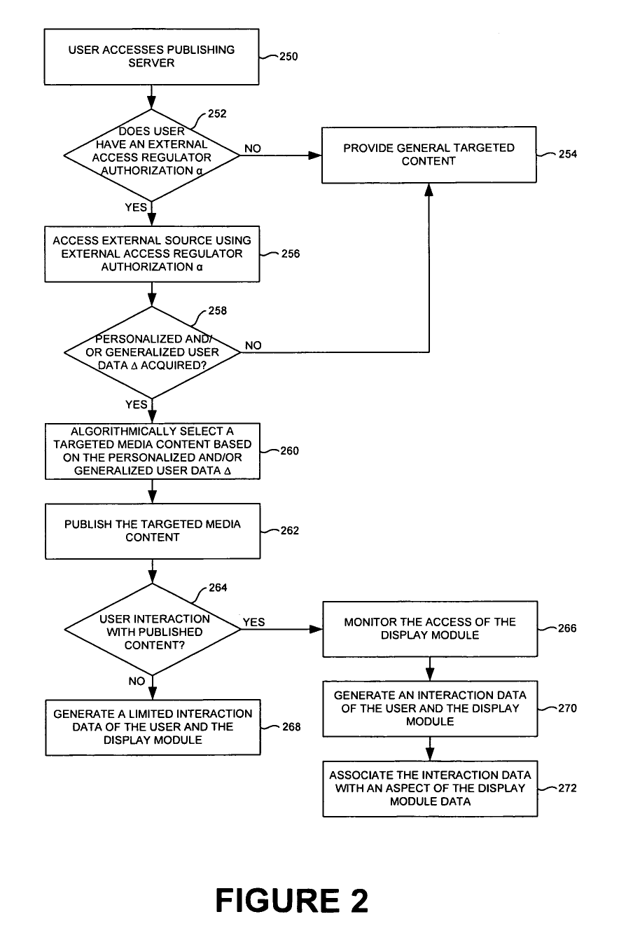

FIG. 2 is an algorithmic view of the user accessing a publishing server, according to one embodiment. In operation 250, the user 112 may access the publishing server 102. In operation 252, it may be determined whether the user 112 has the external access regulator authorization α 116. In operation 254, if the user 112 does not have the external access regulator authorization α 116, then general targeted content may be provided. In operation 256, if the user does have the external access regulator authorization α 116, the capture module 126 may access the external source using the external access regulator authorization α 116.

In operation 258, it may be determined whether the personalized user data Δ 120 and/or the generalized user data 122 were acquired. In operation 254, if the personalized user data Δ 120 and/or the generalized user data 122 were not acquired, then general targeted content may be provided. In operation 260, if the personalized user data Δ 120 and/or the generalized user data 122 was acquired, then the targeted media content may be algorithmically selected based on the personalized and/or the generalized user data Δ. In operation 262, the targeted media content may be published (e.g., displayed, transmitted, broadcast, printed, etc.).

In operation 264, it may be determined whether there has been a user interaction with the display module 104. In operation 266, if there was a user interaction with the display module 104, then the interaction with the display module 104 may be monitored. In operation 268, if there was not a user 112 interaction with the display module 104, then a limited interaction data of the user 112 and the display module 104 may be generated.

In operation 270, the interaction data of the user 112 and the display module 104 may be generated. In operation 272, the interaction data may be associated with an aspect of the display module data 142.

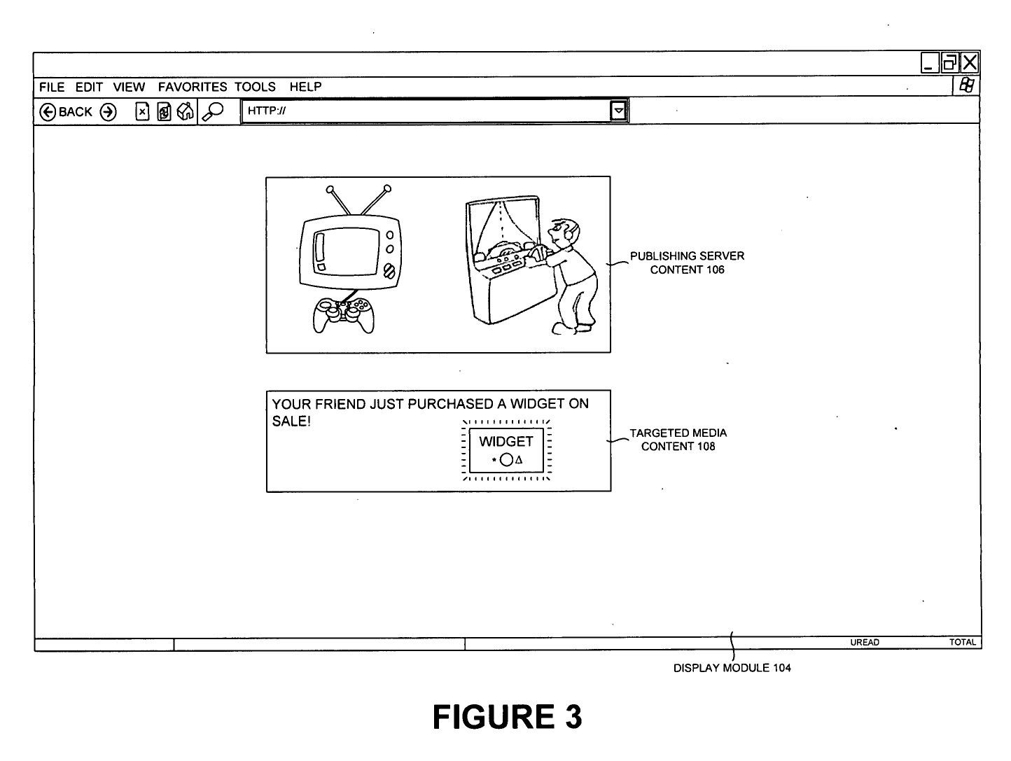

FIG. 3 is a user interface view illustrating a display module, according to another embodiment. Particularly, FIG. 3 illustrates the display module 104, publishing server content 106, and targeted media content 106, according to one embodiment. The display module 104 may publish and/or exhibit the publishing server content 106 and the targeted media content 108. For example, the publishing server content 106 may be a console gaming system (e.g., a Nintendo Wii®, an Xbox 360®, etc.). The targeted media content 108 may be a widget (e.g., a game for the console gaming system, a controller, a television, a PC software, etc.). The targeted media content 108 may include a portion of the personalized user data Δ 120 and/or the generalized user data 122, such as the user 112's friend's name and/or image, a purchasing history of the user 112's friend, a recent status update of the user 112's friend, etc. The user 112 may ignore the content published using the display module 104, click on parts of the web page, click on the targeted media content 104, view a video clip, and/or download an audio file presented using the display module 104. The user 112's actions may be monitored by a receiver module 132 and/or be used to generate an interaction data 136. The user 112's interaction data 136 may be correlated with the display module data 142 (e.g., content actively displayed at the time of viewing, a record of other user's behavior, etc.) to form an association between the user 112 and an aspect of the display module data 140. For example, a statistical association between click through rates for a member of a demographic group (e.g., middle aged men, teenagers, housewives, etc.) may be updated to include the user 112's response to the publishing server content 106 and/or the targeted media content 108.

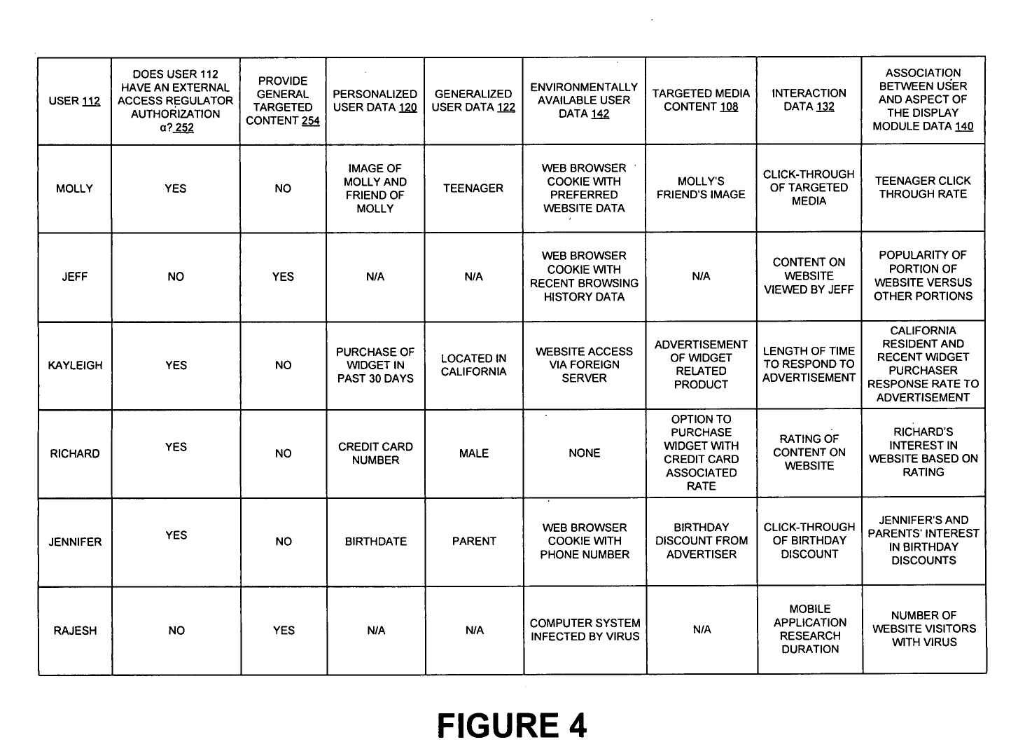

FIG. 4 is a tabular view of acquiring the user data to enhance a content targeting mechanism, according to yet another embodiment. In particular, FIG. 4 illustrates various users accessing the publishing server 102. The publishing server may be the social networking server. The table illustrates various columns for various users and data associated with each of the users. The columns in the table include whether the user 112 has an external access regulator authorization a 252, whether general targeted content is provided 254, examples of personalized user data Δ 120, generalized user data 122, environmentally available user data 142, targeted media content 108, the interaction data 132 for each user, and associations between the user and an aspect of the display module data 140.

In an embodiment, the method includes determining whether the user 112 has an external access regulator authorization α 252, either by detecting the authorization α or by inferring its existence from a process that requires the authorization α. The publishing server 102 may have been accessed using the external access regulator authorization a 252 and/or the publishing server may include the external access regulator.

The method may include providing general targeted content 254 that may relate to the publishing server content 106 if the external access regulator authorization α 252 has not yet been found. For example, a website of a car magazine may publish articles, photos, and videos as publishing server content 106. The general targeted content 254 may be additional articles, photographs, advertisements, and/or text streams related to cars and the articles in the publishing server content 106.

The method may include publishing a part of personalized user data Δ 120 as part of a targeted media content 106 (e.g., an image of Molly and her friend, a widget purchase within the past 30 days, a credit card number, a birthday reminder, etc.). The method may include publishing generalized user data 122 and/or acquiring the generalized user data 122 to accommodate a privacy restriction associated with the external source 118 and/or a policy of the external access regulator. The generalized user data 122 may include a part and/or all of the personalized user data Δ 120. The generalized user data 122 may be an aspect of the user 112 Molly's demographic, such as whether she may be considered a teenager, which may be extrapolated from her birth date. The generalized user data 122 may include an association between the user 122 Kayleigh and California, and an identification of the user 112 Jennifer as a parent.

In an embodiment, an environmentally available user data 142 may be acquired from a user 112's active software and/or data available to the user 112's software. The environmentally available user data 142 may be acquired with or without the external access regulator authorization α 252. The environmentally available user data 142 may include a web browser cookie data that includes preferred websites and/or stored passwords, recent browsing history, a source of access by the user 112 such as through a server of a foreign country, a phone number, and a virus infection status of the user 112's system.

The targeted media content 108 may include data such as Molly's friend's image, an advertisement of a widget related product, and an option to purchase a widget with a credit card associated rate. The targeted media content 108 may include a birthday discount from an advertiser.

The interaction data 132 may include a click-through of the targeted media content 108. The interaction data 132 may include content viewed by the user 112 Jeff, an amount of time between a presentation of an advertisement and a response, a rating of content on a website, and a click-through rate of a birthday discount.

The relation module 138 may generate an association between a user and an aspect of display module data, including a teenager click through rate, and/or a popularity of a portion of a website versus other parts of the same website. The association may further include data such as a California resident and recent widget purchaser response rate to a particular advertisement and/or category of advertisement. The association may be a response rate of a particular user 112 (e.g., Jeff) to different ads as compared with his historical response rates. The association between a user 112 and an aspect of display module data may include a particular user 112's interest in a website based on a rating provided by the user 112. Users for whom personalized user data Δ 120 and/or the external access regulator authorization α 252 may be monitored and included into an overall visitor statistic used to further develop and/or select the targeted media content 108 (e.g., logging the number of visitors to the site with a virus, etc.).

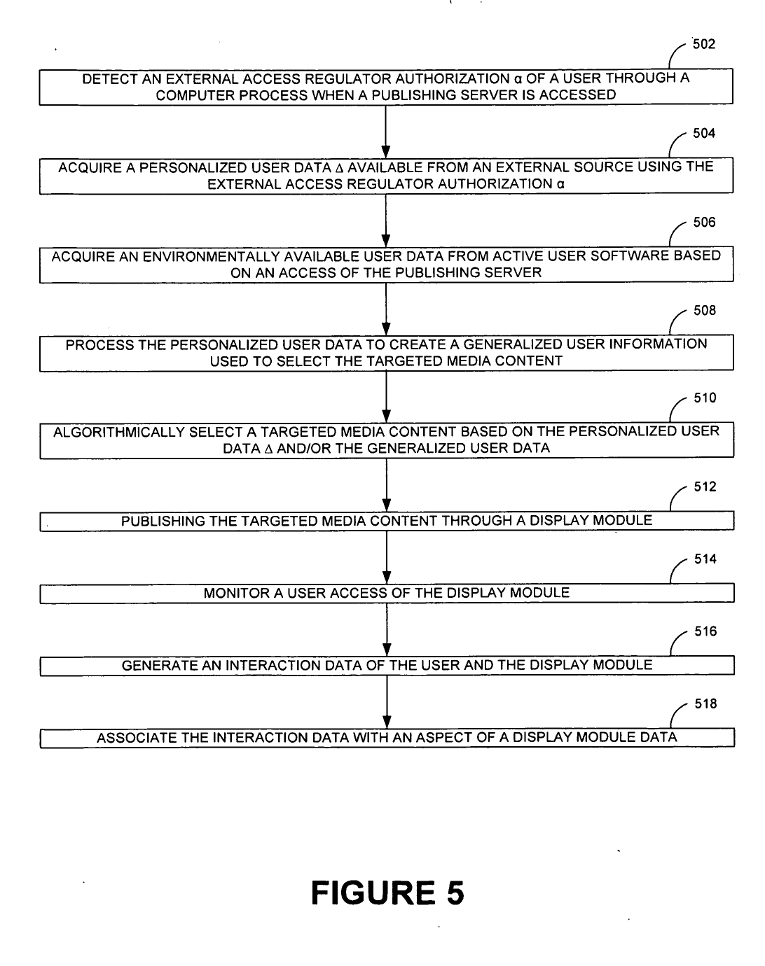

FIG. 5 is a process flow illustrating detection of an external access regulator authorization α, according to one embodiment. In operation 502, an external access regulator authorization α of a user may be detected through a computer process after a publishing server has been accessed. In operation 504, a personalized user data Δ available from an external source may be acquired using the external access regulator authorization α. The personalized user data Δ may be acquired using the capture module 126, which may include a component executing on the client device 110 and a component executing on a server. In operation 506, an environmentally available user data 142 may be acquired from active user software based on an access of the publishing server. For example, a cookie may be acquired from the user 112's client device 110 by the additional component of the capture module 126. In operation 508, the personalized user data may be processed to create generalized user information used to select the targeted media content.

In operation 510, the targeted media content 108 may be algorithmically selected based on the personalized user data Δ 120 and/or the generalized user data 122. The algorithmic selection may be performed using the association module 130, which may use information from a media database 128. The association module 130 may have access to user data from the external source 118 and/or an internal source of user data. Examples of internal sources of user data may include the client device 110, the publishing server 102, the media database 128, and/or a marketing network server. In operation 512, the targeted media content may be published through the display module 104. In operation 514, a user access of the display module 104 may be monitored. In operation 516, an interaction data of the user and the display module 104 may be generated. In operation 518, the interaction data may be associated with an aspect of a display module data.

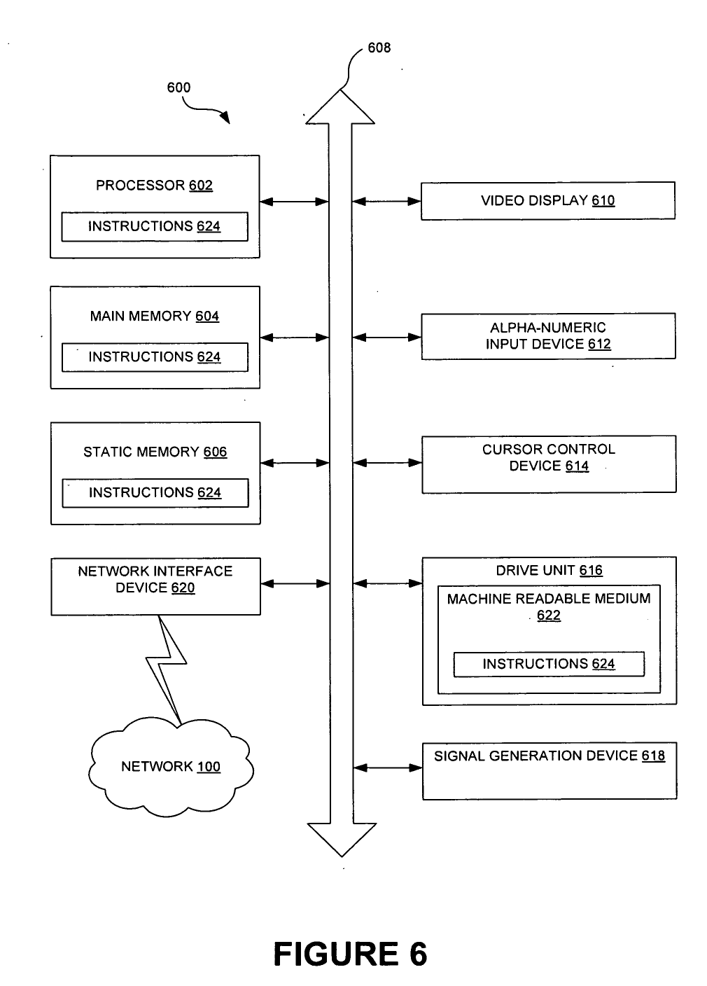

FIG. 6 is a diagrammatic system view of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 100, according to one embodiment.

The diagrammatic system view 600 may indicate a personal computer and/or the data processing system in which one or more operations disclosed herein are performed. The processor 602 may be a microprocessor, a state machine, an application specific integrated circuit, a field programmable gate array, etc. (e.g., Intel® Pentium® processor). The main memory 604 may be a dynamic random access memory and/or a primary memory of a computer system.

The static memory 606 may be a hard drive, a flash drive, and/or other memory information associated with the data processing system. The bus 608 may be an interconnection between various circuits and/or structures of the data processing system. The video display 610 may provide graphical representation of information on the data processing system. The alpha-numeric input device 612 may be a keypad, a keyboard and/or any other input device of text (e.g., a special device to aid the physically handicapped).

The cursor control device 614 may be a pointing device such as a mouse. The drive unit 616 may be the hard drive, a storage system, and/or other longer term storage subsystem. The signal generation device 618 may be a bios and/or a functional operating system of the data processing system. The network interface device 620 may be a device that performs interface functions such as code conversion, protocol conversion and/or buffering required for communication to and from the network 100. The machine readable medium 622 may provide instructions on which any of the methods disclosed herein may be performed. The instructions 624 may provide source code and/or data code to the processor 602 to enable any one or more operations disclosed herein.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry). Particularly, the display module 104, the client device 110, the observation module 114, the capture module 126, the media database 128, the association module 130, the receiver module 132, the interaction analysis module 134, and the association module 138 of FIG. 1 may be enabled using software and/or circuits.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
acquiring a personalized user data Δ available from an external source using an external access regulator authorization a;
algorithmically selecting a targeted media content based on the personalized user data Δ; and
publishing the targeted media content through a display module.

2. The method of claim 1, further comprising:
detecting an external access regulator authorization a of a user through a computer process after a publishing server has been accessed;
monitoring a user access of the display module;
generating an interaction data of the user and the display module; and
correlating the interaction data with an aspect of a display module data.

3. The method of claim 2, wherein the interaction data includes at least one of a click-through, a viewed content, a time of viewing, a viewing rate, a rating, and a communication.

4. The method of claim 1, wherein an external access regulator is operated by a social networking server.

5. The method of claim 1, wherein the external source is a social networking server.

6. The method of claim 1, wherein the personalized user data includes at least one of a name, an age, a gender, an image, an interest, an associated account, a communication, a social graph, a social network, a purchase activity, an installed application, and an account history.

7. The method of claim 6, wherein the targeted media content includes a portion of the personalized user data Δ that relates to at least one of a user and an additional user that is socially connected to the user.

8. The method of claim 7, wherein the personalized user data Δ includes an image of at least one of the user and the additional user.

9. The method of claim 2, wherein the interaction data is used to perform the algorithmic selection of the targeted media content.

10. The method of claim 1, further comprising acquiring an environmentally available user data from active user software based on an access of a publishing server, wherein the environmentally available user data affects the algorithmic selection of the targeted media content.

11. The method of claim 1, further comprising processing the personalized user data to create a generalized user information used to select the targeted media content.

12. The method of claim 1, wherein the external access regulator authorization α is detected by inferring an existence of the external access regulator authorization α based on a publishing server process that requires the external access regulator authorization α.

13. A system comprising:
a capture module that acquires a personalized user data Δ available from an external source using an external access regulator authorization a;
an association module to algorithmically select a targeted media content from a database using a computer process based on at least one of the personalized user data Δ and an internal source of user data; and
a display module to publish the targeted media content.

14. The system of claim 13, further comprising:
an observation module that detects the external access regulator authorization a of a user through a computer process after a publishing server has been accessed;
a receiver module to monitor a user access of the display module;
an interaction analysis module to generate an interaction data of the user and the display module; and
a relation module to correlate the interaction data with an aspect of a display module data.

15. The system of claim 14, wherein the interaction data of the user and the display module includes at least one of a click-through, a viewed content, a time of viewing, a viewing rate, a rating, and a communication.

16. The system of claim 14, wherein at least one of the observation module and the capture module are executed on a client device.

17. The system of claim 14, wherein a component of the capture module is executed on a client device and an additional component of the capture module is executed on a server.

18. The system of claim 13, wherein an external access regulator is operated by a social networking server, and wherein the external source is a social networking server.

19. A method comprising:
detecting an external access regulator authorization a of a user through a computer process after a publishing server has been accessed, wherein an external access regulator is operated by a social networking server;
acquiring a personalized user data Δ available from the social networking server using the external access regulator authorization α, wherein the personalized user data Δ relates to at least one of the user and an additional user that is socially connected to the user;
algorithmically selecting a targeted media content based on the personalized user data Δ;
publishing the targeted media content through a display module;
monitoring a user access of the display module;
generating an interaction data of the user and the display module that includes at least one of a click-through, a viewed content, a time of viewing, a viewing rate, a rating, and a communication; and
correlating the interaction data with an aspect of a display module data.

20. The method of claim 19, wherein the personalized user data includes at least one of a name, an age, a gender, an image, an interest, an associated account, a communication, a social graph, a social network, a purchase activity, an installed application, and an account history.
